(19) United States
(12) Patent Application Publication
(10) Pub. No.: US 2015/0081149 A1
(43) Pub. Date: Mar. 19, 2015

(54) Communications Device for Vehicle and Communications System for Vehicle

(71) Applicant: Hitachi Automotive Systems, Ltd., Hitachinaka-shi, Ibaraki (JP)

(72) Inventors: Kazuya Takahashi, Sagamihara-shi (JP); Tatsuyuki Yamamoto, Isehara-shi (JP)

(73) Assignee: Hitachi Automotive Systems, Ltd., Hitachinaka-shi, Ibaraki (JP)

(21) Appl. No.: 14/384,513

(22) PCT Filed: Mar. 7, 2013
(86) PCT No.: PCT/JP2013/056308

§ 371 Date: Sep. 11, 2014

(30) Foreign Application Priority Data
Mar. 13, 2012 (JP) 2012-055301

(51) Int. Cl. G01C 21/26; H04W 4/02

(52) U.S. Cl. CPC G01C 21/26; H04W 4/028
USPC 701/22; 455/456.1; 701/537

(57) ABSTRACT

A communications device for a vehicle includes a vehicle-travel-data accumulating unit mounted in the vehicle and configured to accumulate a travel data of the vehicle; a communication unit provided for mobile communications and configured to send a partial data of the vehicle travel data accumulated in the vehicle-travel-data accumulating unit to an external server, and to receive a necessary information from the server; and a communication unit provided for fixed-line communications and configured to send the vehicle travel data accumulated in the vehicle-travel-data accumulating unit to the server when the vehicle is in a stopped state.

### TECHNICAL FIELD

The present invention relates to a communications device or system for a vehicle in which communications for necessary information are performed between the vehicle and a data center, more particularly, relates to a communications device or system for a vehicle in which a mobile communication and a fixed-line communication are appropriately combined with each other to ensure an adequate information-processing amount and also to reduce a communication cost.

### BACKGROUND ART

As is known today, a traffic information (including a travel data of vehicle) detected by sensors provided in the vehicle and on a road is collected by a base station such as an information center, and then, the base station delivers an edited and processed result of the traffic information as a road traffic information or the like by way of trial. For example, Patent Literature 1 proposes this kind of system. In this technique, a traffic information transmitting system alternately repeats a collection of traffic information and a sending of the collected traffic information. Moreover, a time interval of the sending of traffic information is varied according to a traffic situation.

However, in the conventional technique as disclosed in Patent Literature 1, communications are performed only by a mobile communication line or the like. Hence, a communication data amount is varied according to situations in order to suppress a pay-as-you-go charge (a charge proportional to the amount of use) for the mobile communication line. However, a data amount cannot be necessarily suppressed to a minimum, so that there is a ceiling to reduce the communication cost. On the other hand, in an electric vehicle that has lately started to grow popular, a large amount of data can be uploaded via a broadband line by using a fixed-line communication during a recharging of the electric vehicle. However, the large amount of travel data cannot be effectively utilized with little flexibility because, for example, the travel data of the vehicle is accumulated during a running of the vehicle and then is uploaded at the time of recharging of the vehicle. Accordingly, a simultaneous pursuit of the reduction in communication cost and the sufficient processing amount of information is not attained.

### CITATION LIST

### Patent Literature

Patent Literature 1: Japanese Patent Application Publication No. 2004-287724

### SUMMARY OF THE INVENTION

It is therefore an object of the present invention to provide a communications device for a vehicle and a communications system for a vehicle, devised to effectively utilize a large amount of travel data and to attain both of the reduction in communication cost and the sufficient amount of processed information.

A vehicular communications device according to the present invention comprises: a vehicle-travel-data accumulating unit provided in the vehicle and configured to accumulate a travel data of the vehicle; a communication unit provided in the vehicle for mobile communications, the communication unit being configured to send a partial data of the vehicle travel data accumulated in the vehicle-travel-data accumulating unit to an external server, and to receive a necessary information from the server; and a communication unit provided for fixed-line communications and configured to send the vehicle travel data accumulated in the vehicle-travel-data accumulating unit to the server when the vehicle is in a stopped state.

According to the present invention, the communication unit for mobile communications as typified by a cellular-phone unit and the communication unit for fixed-line communications which uses an optical broadband line or the like are provided together. Hence, the large amount of travel data can be uploaded to the server while suppressing the communication cost. Therefore, the large amount of travel data can be effectively utilized while attaining both of the reduction in communication cost and the sufficient processing amount of information.

### BRIEF EXPLANATION OF DRAWINGS

FIG. 1 A block circuit diagram showing a first embodiment of a vehicular communications device according to the present invention.

FIG. 2 A flowchart illustrating an operating procedure in a vehicle side of FIG. 1.

FIG. 3 A flowchart illustrating an operating procedure in a data center side of FIG. 1.

FIG. 4 A block circuit diagram showing a second embodiment of the vehicular communications device according to the present invention.

FIG. 5 A flowchart illustrating an operating procedure in a vehicle side of FIG. 4.

FIG. 6 A flowchart illustrating an operating procedure in a data center side of FIG. 4.

### DETAILED DESCRIPTION OF INVENTION

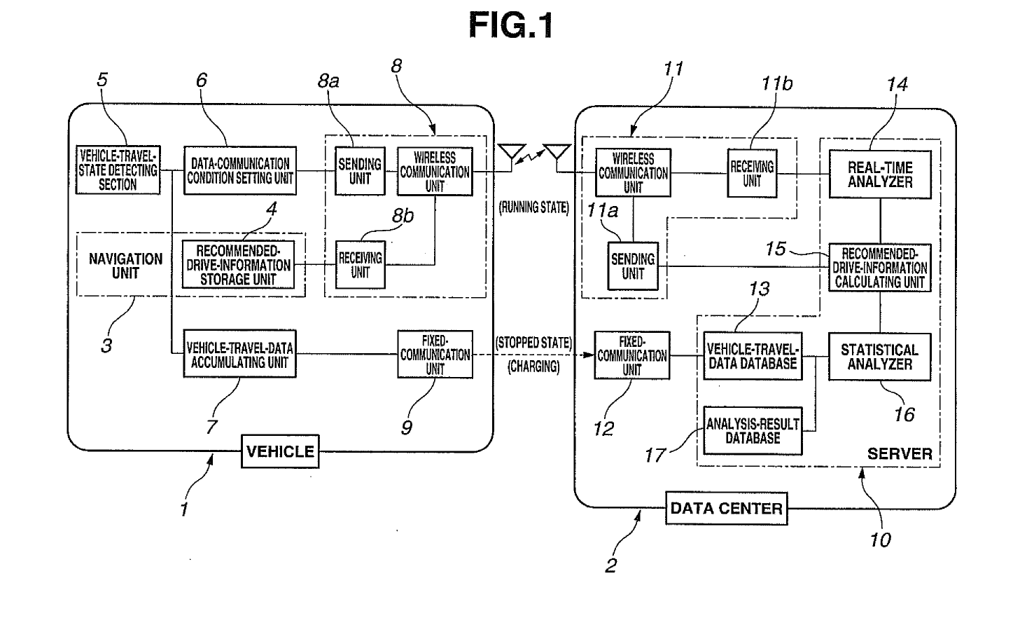

FIG. 1 is a schematic explanatory view showing a first embodiment of a vehicular communications device (vehicular communications system) according to the present invention. A reference sign 1 denotes a vehicle (vehicle side), and a reference sign 2 denotes a data center (data-center side) which functions as a base station.

As shown in FIG. 1, the vehicle (vehicle side) 1 includes a navigation unit 3, a vehicle-travel-state detecting section 5, a data-communication condition setting unit 6, a vehicle-travel-data accumulating unit 7, a wireless communication unit 8 for mobile wireless communications, and a fixed-communication unit 9 for fixed-line communications (local-area communications). The navigation unit 3 includes a recommended-drive-information storage unit 4. The wireless communication unit 8 is, for example, a cellular-phone unit. The fixed-communication unit 9 constitutes, for example, a wireless or wired LAN which uses (is directly connected with) an optical broadband line. This fixed-communication unit 9 is mounted in advance in the vehicle 1 as a terminal for fixed-line communications. At least the wireless communication unit 8 for mobile wireless communications includes a sending unit 8a and a receiving unit 8b for purpose of bidirectional (two-way) communications.

On the other hand, the data center (data-center side) 2 which functions as the base station includes a server 10, a wireless communication unit 11, and a fixed-communication unit 12 for fixed-line communications. The wireless communication unit 11 communicates with the vehicle (vehicle side) 1, for example, with the cellular-phone unit of the vehicle 1, by mobile wireless communications. The fixed-communication unit 12 uses an optical broadband line or the like.

At least the wireless communication unit 11 for mobile wireless communications includes a sending unit 11a and a receiving unit 11b for purpose of bidirectional (two-way) communications.

The server 10 is constituted by a vehicle-travel-data database 13, a real-time analyzer 14, a recommended-drive-information calculating unit 15, a statistical analyzer 16, and an analysis-result database 17. The vehicle-travel-data database 13 accumulates an after-mentioned vehicle travel data.

Respective hardware itself which constitutes the data center 2 is constructed as a general computer system. For example, a function as the server 10 and a function as a host computer in the data center 2 may be furnished by substantially one computer.

In the vehicle side 1, during a running of the vehicle 1, the vehicle-travel-state detecting section 5 detects and collects driver's manipulation amounts such as an accelerator manipulation amount, a brake manipulation amount and a steering-wheel manipulation amount; running data of the vehicle 1 such as a vehicle speed, an acceleration, a yaw rate and a location information obtained by GPS; and a failure information, as a large amount of detailed vehicle travel data (also called “probe data”). Then, the vehicle-travel-state detecting section 5 sequentially stores and accumulates this data (information) in the vehicle-travel-data accumulating unit 7 as a time-series data together with a time information (including date information) which represents a time at which this data was detected. It is noted that the vehicle-travel-data accumulating unit 7 is mounted underneath the vehicle 1.

Then, a data volume of this accumulated vehicle travel data is reduced by the data-communication condition setting unit 6 in a predetermined format such as a data thinning processing or a data compression processing. As a result, this accumulated vehicle travel data is converted into a minimum necessary real-time travel data. The wireless communication unit 8 for mobile wireless communications sends this real-time travel data to the data center 2 in real time during the running of the vehicle 1. It is noted that the above-mentioned process for reducing data volume such as the data thinning processing or the data compression processing is done in order to reduce a communication airtime and a communication cost. For example, the detected vehicle travel data is thinned into (is cut to reserve) only a high-priority and high-importance data such that the real-time travel data having a minimum necessary information volume is obtained.

On the other hand, when the vehicle 1 is in a stopped state, for example, when the vehicle 1 is in a parked state at home, a large amount of detailed past-accumulated vehicle travel data (i.e., the vehicle travel data which has not yet been treated by the above-mentioned data thinning processing or the like) which was accumulated in the vehicle-travel-data accumulating unit 7 of the vehicle 1 is sent (uploaded) to the data center 2 by the fixed-communication unit 9 provided for fixed-line communications (such as wireless or wired LAN). This detailed past-accumulated vehicle travel data is a past vehicle travel data which exists in the vehicle-travel-data accumulating unit 7 and which was accumulated after (a last-time data sending during) a previous parking of the vehicle 1. This past-accumulated vehicle travel data which exists in the vehicle-travel-data accumulating unit 7 is deleted from the vehicle-travel-data accumulating unit 7 when this past-accumulated vehicle travel data has just been received by the data center 2.

Moreover, during the running of the vehicle 1, in addition to the above-mentioned real-time sending of the real-time travel data, the wireless communication unit 8 for mobile wireless communications receives a data sent from the data center 2. For example, as mentioned later, a recommended drive route information is received as a recommended drive information calculated in the data center 2. This recommended drive route information is memorized and stored in the recommended-drive-information storage unit 4 of the navigation unit 3, so that the recommended drive route information is used as a route guide for the driver together with a route-guidance function of the navigation unit 3 or in place of the route-guidance function of the navigation unit 3.

The data center 2 which functions as the base station forms the foundation of a system which manages information of a plurality of vehicles (so-called probe cars). As mentioned before, the data center 2 receives (uploads) the large amount of detailed past-accumulated vehicle travel data which was memorized and accumulated by each vehicle 1 during the running of the vehicle, through the fixed-communication unit 12 during the parking or the like of the vehicle 1. Then, this large amount of detailed past-accumulated vehicle travel data is accumulated in the vehicle-travel-data database 13 of the server 10.

In the server 10, the statistical analyzer 16 conducts a statistical analysis of traffic-jam situation and the like of each road for every date and time (i.e., analysis disaggregated by date and hour), on the basis of the detailed past-accumulated vehicle travel data of the vehicle 1 accumulated in the vehicle-travel-data database 13. For example, the statistical analyzer 16 calculates a detailed drive information on the basis of the past-accumulated vehicle travel data including a travel history of the vehicle 1. This detailed drive information includes a plurality of recommended drive-route plans necessary to move between representative sites, which are determined according to respective conditions such as date-and-hour, time zone and/or traffic-jam situation. Then, this detailed drive information is accumulated in the analysis-result database 17.

Moreover, as mentioned above, the data center 2 receives the real-time travel data sent in real time from the running vehicle 1, through the wireless communication unit 11 provided for mobile communications. Then, the real-time analyzer 14 of the data center 2 analyzes a current traveling/driving situation of the vehicle 1 on the basis of the real-time travel data. This traveling/driving situation of the currently-running vehicle 1 which is an analysis result of the real-time analyzer 14 is received by the recommended-drive-information calculating unit 15. The recommended-drive-information calculating unit 15 checks the traveling/driving situation of the currently-running vehicle 1 against a huge amount of detailed drive information accumulated in the analysis-result database 17. Thereby, in real time, the recommended-drive-information calculating unit 15 analyzes which pattern included in the huge amount of detailed drive information accumulated in the analysis-result database 17 is close to the current traveling/driving situation of the vehicle 1. That is, a pattern close to the current traveling/driving situation of the vehicle 1 is searched from many patterns of the huge amount of detailed drive information. Thereby, the recommended-drive-information calculating unit 15 calculates a recommended drive information corresponding to the pattern obtained from the huge amount of detailed drive information.

This recommended drive information is formed by simplifying the detailed drive information of the obtained pattern, and is a minimum necessary information which is high in priority and importance for the vehicle 1. Specifically, this recommended drive information is the recommended drive route information. Then, the recommended drive information calculated as mentioned above is sent in real time to the currently-running vehicle 1 through the wireless communication unit 11 provided for mobile wireless communications.

In the side of the running vehicle 1, the wireless communication unit 8 for mobile communications receives the recommended drive information (the recommended drive route information) sent from the side of the data center 2. The recommended-drive-information storage unit 4 of the navigation unit 3 memorizes and stores the recommended drive information (the recommended drive route information). Then, as mentioned before, the recommended drive information is used as a route guide for the driver together with the route-guidance function of the navigation unit 3 or in place of the route-guidance function of the navigation unit 3.

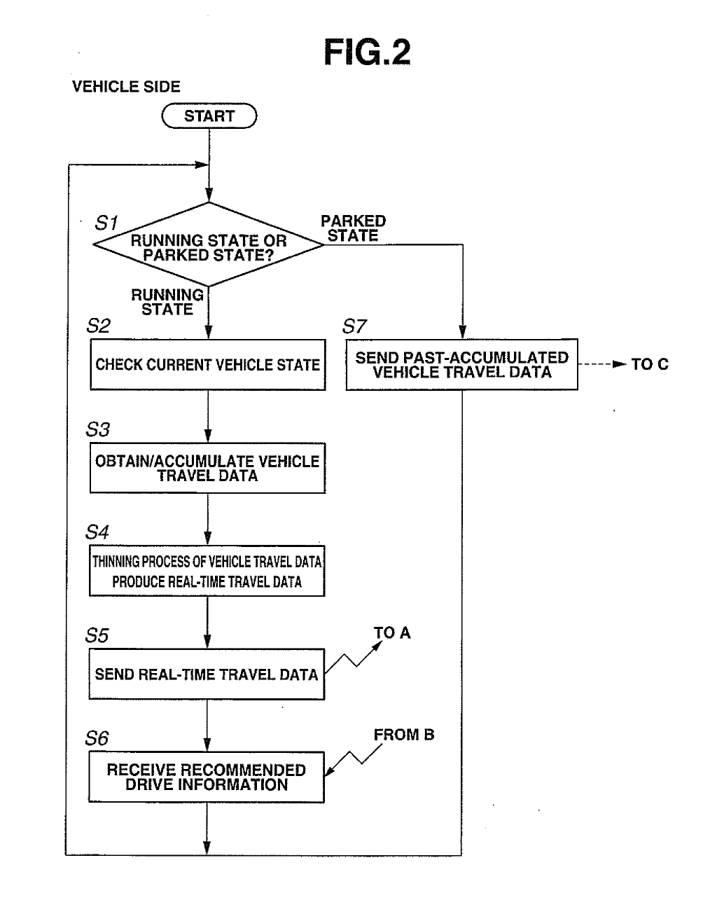

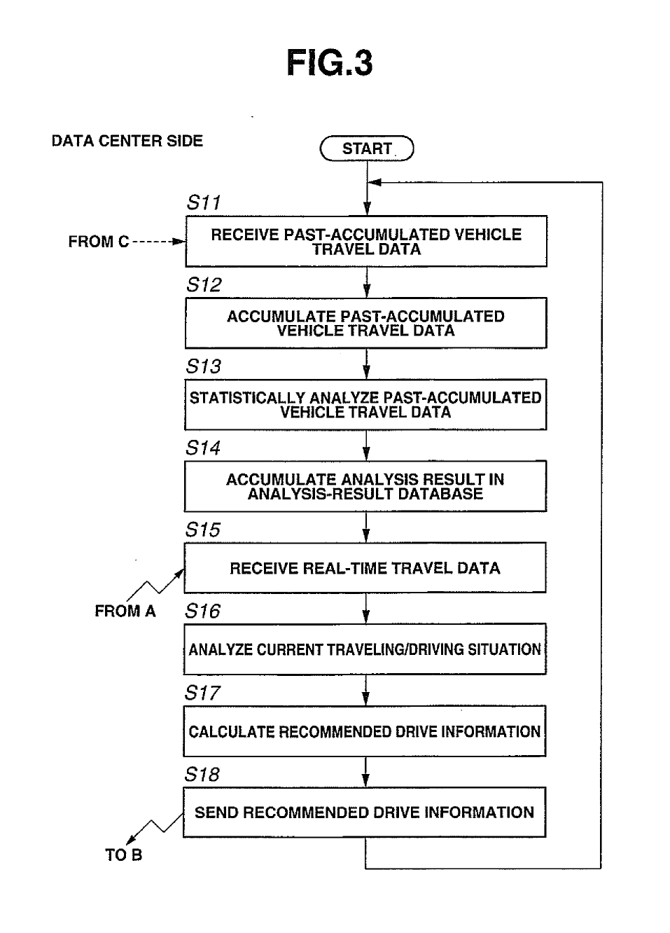

Next, handling procedures which are executed in the system of FIG. 1 will now be explained referring to flowcharts of FIGS. 2 and 3.

FIG. 2 illustrates a handling procedure which is executed in the side of vehicle 1. FIG. 3 illustrates a handling procedure which is executed in the side of data center 2. In the side of vehicle 1, processing of steps S1 to S7 of FIG. 2 is repeatedly executed at predetermined intervals. On the other hand, in the side of data center 2, processing of steps S11 to S16 of FIG. 3 is executed in response to a transceiving access from the vehicle 1.

At first, at step S1 of FIG. 2, it is judged whether the vehicle (host vehicle) 1 is in the running state or in the parked state. If the vehicle 1 is in the running state, the program proceeds to step S2. At step S2, a current state of the vehicle 1 is checked. At step S3, the vehicle-travel-state detecting section 5 of FIG. 1 detects and collects (obtains) the amounts of driver's manipulations such as the accelerator manipulation amount, the brake manipulation amount and the steering-wheel manipulation amount; the running data of vehicle 1 such as the vehicle speed, the acceleration, the yaw rate and the location information obtained by GPS; and the failure information, as the large amount of detailed vehicle travel data. Moreover, at step S3, this vehicle travel data is memorized and accumulated in the vehicle-travel-data accumulating unit 7 in a time-series manner together with a detection-time information (including date information) which represents a time at which this vehicle travel data was detected. When this vehicle travel data has been memorized and accumulated in the vehicle-travel-data accumulating unit 7, this vehicle travel data loses its freshness (newness) and thereby becomes the past-accumulated vehicle travel data.

At step S4, the vehicle travel data accumulated in the vehicle-travel-data accumulating unit 7 as the past-accumulated vehicle travel data is reduced in volume in the predetermined format by the data thinning processing or the like of the data-communication condition setting unit 6. Thereby, this vehicle travel data is converted into the minimum necessary real-time travel data. Then, at step S5, the wireless communication unit 8 for mobile communications sends this real-time travel data to the data center 2 in real time during the running of the vehicle 1.

On the other hand, the data center side 2 receives the real-time travel data from the vehicle side 1 as a processing of step S15 of FIG. 3. Then, as a processing of step S16, the real-time analyzer 14 of FIG. 1 analyzes the current traveling/driving situation of the vehicle 1 on the basis of the real-time travel data.

The recommended-drive-information calculating unit 15 of FIG. 1 obtains the traveling/driving situation of the currently-running vehicle 1 which is the analysis result of the real-time analyzer 14. At step S17, the recommended-drive-information calculating unit 15 matches (checks) the traveling/driving situation of the currently-running vehicle 1 to (against) the huge amount of detailed drive information accumulated in the analysis-result database 17. Thereby, in real time, the recommended-drive-information calculating unit 15 analyzes which pattern included in the huge amount of detailed drive information is similar to the current traveling/driving situation of the vehicle 1. That is, a pattern similar to the current traveling/driving situation of the vehicle 1 is searched from many patterns of the huge amount of detailed drive information. Thereby, the recommended-drive-information calculating unit 15 calculates the recommended drive information (the recommended drive route information) corresponding to the pattern obtained from the huge amount of detailed drive information. It is noted that detailed traffic drive information which exists in the analysis-result database 17 will be explained later.

At step S18, the recommended drive information calculated at step S17 is sent in real time to the currently-running vehicle 1 through the wireless communication unit 11 provided for mobile communications.

In the vehicle side 1, at step S6 subsequent to the access timing for sending the real-time travel data of step S5 of FIG. 2, the wireless communication unit 8 of FIG. 1 receives the recommended drive information (the recommended drive route information) calculated by the recommended-drive-information calculating unit 15 of the data center 2. Then, the wireless communication unit 8 memorizes and stores the recommended drive information in the recommended-drive-information storage unit 4 of the navigation unit 3. Thus, the recommended drive information (the recommended drive route information) received from the data center 2 is utilized as a route guide for the driver together with the route-guidance function of the navigation unit 3 itself or in place of the route-guidance function of the navigation unit 3.

If it is determined that the vehicle is in the parked state at step S1 of FIG. 2, the program immediately proceeds to step S7. At step S7, if the vehicle 1 is in the parked state, for example, at home and also if the fixed-communication unit 9 provided for fixed-line communications (such as wireless or wired LAN) shown in FIG. 1 is able to communicate with the data center 2, then the large amount of detailed past-accumulated vehicle travel data which exists in the vehicle-travel-data accumulating unit 7 of the vehicle 1 is sent to the data center 2.

As mentioned above, on condition that the vehicle 1 is parked at home or the like and also the fixed-communication unit 9 provided for fixed-line communications (such as wireless LAN or wired LAN) is ready to communicate with the data center 2, the vehicle 1 sends the large amount of detailed past-accumulated vehicle travel data (i.e., vehicle travel data which has not yet been treated by the above-mentioned data thinning processing or the like) of the vehicle-travel-data accumulating unit 7 to the data center 2. Hence, at step S11 of FIG. 3, the data center side 2 receives the large amount of detailed past-accumulated vehicle travel data via the fixed-communication unit 12 of FIG. 1. At next step S12, this detailed past-accumulated vehicle travel data is accumulated in the vehicle-travel-data database 13 of FIG. 1.

Next, at step S13, the statistical analyzer 16 of FIG. 1 analyzes the traffic-jam situation and the like of each road for every date and time on the basis of the detailed vehicle travel data of vehicle 1 accumulated in the vehicle-travel-data database 13. For example, as mentioned before, the statistical analyzer 16 of the server 10 calculates a detailed drive information on the basis of the past-accumulated vehicle travel data including the travel history of the vehicle 1. This detailed drive information includes a plurality of recommended drive-route plans necessary to move between representative locations, which are given according to respective conditions such as date-and-hour, time zone and/or traffic-jam situation. At next step S14, this detailed drive information obtained as an analysis result is accumulated and retained in the analysis-result database 17.

As mentioned before, the detailed drive information accumulated in the analysis-result database 17 of the server 10 is used for determining or analyzing the recommended drive information (recommended drive route information) according to the real-time travel data when the vehicle 1 in the running state has access to the data center 2 by sending the real-time travel data.

According to this embodiment, for purpose of communicating between the vehicle 1 and the data center 2, both of the wireless communication unit 8, 11 for mobile communications and the fixed-communication unit 9, 12 for fixed-line communications which utilize the optical broadband line or the like are provided and used. When a real-time communication is required during the running of the vehicle 1, the minimum necessary information is sent and received by using the wireless communication unit 8, 11 for mobile communications. On the other hand, when the vehicle 1 is in the parked state at home or the like, the large amount of information is sent and received by using the fixed-communication unit 9, 12. That is, an information communication volume which is transferred by the real-time mobile communications is suppressed to a minimum, whereas the large amount of information is uploaded to the data center side 2 by the fixed communication line. It is noted that a charge for most of the real-time mobile communications is on as-used basis (pay-as-you-go) whereas a charge for the fixed communication line is not on as-used basis.

Therefore, the large amount of vehicle travel data can be uploaded to the server 10 while suppressing the communication cost. That is, both of the reduction of communication cost and a sufficient amount of information processing are attained, so that the large amount of vehicle travel data can be efficiently used for guiding the driver to an optimal route of the vehicle 1. Moreover, the recommended drive route information can be effectively calculated because the recommended-drive-information calculating unit 15 is provided.

The system as shown in FIG. 1 is applicable also to an electric vehicle (including a plug-in hybrid vehicle). Hence, in FIG. 1, “charging” is described in parallel with a description “stopped state”. In the case of electric vehicle, it is known that the vehicle needs to be recharged under the parked state of the vehicle at home or the like.

Accordingly, the system 1 as shown in FIG. 1 is employed also for the electric vehicle. In this case, the sending of the large amount of past-accumulated vehicle travel data of step S7 of FIG. 2 and the receiving of the past-accumulated vehicle travel data of step S11 of FIG. 3 are conducted during recharging of the vehicle. In the case of electric vehicle, when the large amount of vehicle travel data is required to be sent or received, the large amount of vehicle travel data can be sent and received through another fixed communication line by using a charging cable as a communication line (i.e., by way of a so-called power-line carrier communication means), in addition to the fixed-communication unit 9, 12 provided for fixed-line communications such as the wireless or wired LAN which uses (is directly connected with) the optical broadband line as mentioned above.

In the case that the charging cable is used as the communication line, there is a advantage that any communication cable is unnecessary while a charging time can be effectively utilized.

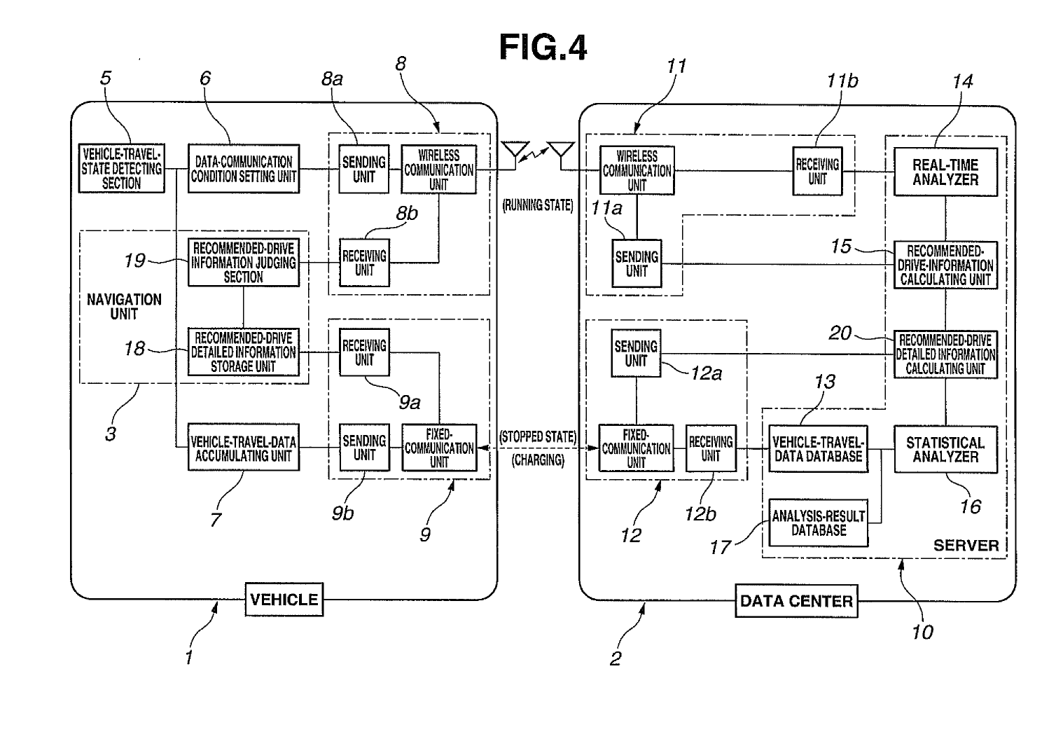

FIG. 4 is a schematic explanatory view showing a second embodiment of a vehicular communications device (vehicular communications system) according to the present invention. The same reference signs are given to the components which are in common with FIG. 1.

In the second embodiment, as is clearly shown when compared with FIG. 1 by which the first embodiment has been explained, the navigation unit 3 of vehicle 1 includes a recommended-drive detailed information storage unit 18 and a recommended-drive information judging section 19 in place of the recommended-drive-information storage unit 4 of FIG. 1. Moreover, the server 10 of the data center 2 includes a recommended-drive detailed information calculating unit 20 in addition to the recommended-drive-information calculating unit 15. Moreover, as compared with the configuration of FIG. 1, the fixed-communication unit 9, 12 provided for fixed-line communications in the vehicle 1 and the data center 2 includes a sending unit 9a, 12a and a receiving unit 9b, 12b individually in order to enable bidirectional (two-way) communications.

The recommended-drive detailed information storage unit 18 of the navigation unit 3 has a function equivalent to the analysis-result database 17 of the data center 2.

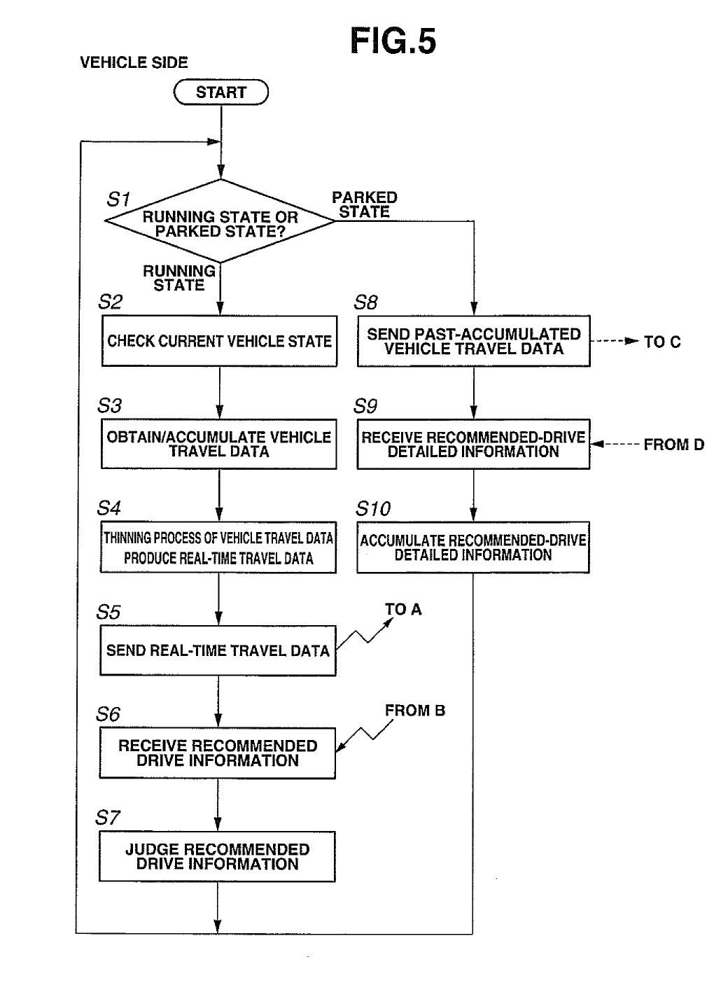

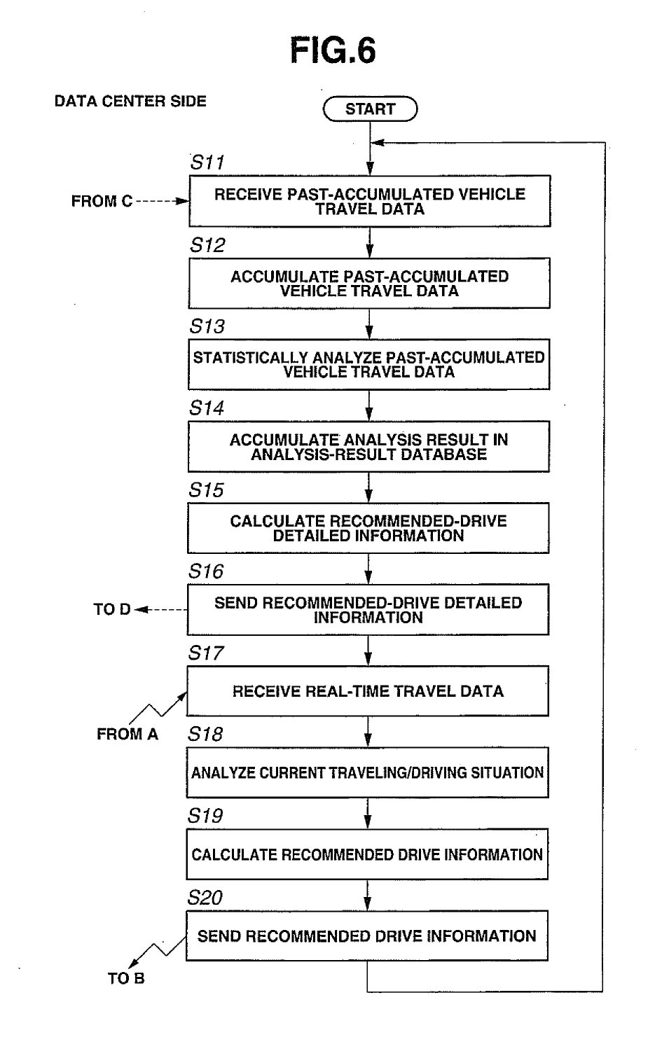

Handling procedures which are executed in the system of FIG. 4 are shown in FIGS. 5 and 6. FIG. 5 illustrates a handling procedure which is executed in the side of vehicle 1. FIG. 6 illustrates a handling procedure which is executed in the side of data center 2. In the handling procedure of the vehicle 1 shown in FIG. 5, processing of steps S7, S9 and S10 is added to the case of FIG. 2. In the handling procedure of the data center 2 shown in FIG. 6, processing of steps S15 and S16 is added to the case of FIG. 3.

For purpose of facilitating understanding of the whole, the procedure of the data center 2 shown by FIG. 6 will now be explained at first. The steps from S11 to S14 of FIG. 6 are the same as FIG. 3.

That is, as mentioned above, on condition that the vehicle 1 is in the parked state at home or the like and also the fixed-communication unit 9 provided for fixed-line communications (such as wireless LAN or wired LAN) is able to communicate with the data center 2, the vehicle 1 sends the large amount of detailed past-accumulated vehicle travel data of the vehicle-travel-data accumulating unit 7 to the data center 2. Hence, at step S11 of FIG. 6, the data center 2 receives the large amount of detailed past-accumulated vehicle travel data via the fixed-communication unit 12 of FIG. 4. At next step S12, this detailed past-accumulated vehicle travel data is accumulated in the vehicle-travel-data database 13 of FIG. 4.

Next, at step S13, the statistical analyzer 16 of FIG. 4 performs the statistical analysis of the traffic-jam situation and the like of each road for every date and time, on the basis of the past-accumulated vehicle travel data of vehicle 1 accumulated in the vehicle-travel-data database 13. For example, as mentioned before, the statistical analyzer 16 of the server 10 shown by FIG. 4 calculates a detailed drive information on the basis of the past-accumulated vehicle travel data including the travel history of the vehicle 1. This detailed drive information is, for example, a plurality of recommended drive-route plans necessary to move between representative sites, which are given according to respective conditions such as date-and-hour, time zone and/or traffic-jam situation. At next step S14, this detailed drive information obtained as an analysis result is accumulated in the analysis-result database 17.

As a processing of step S15 subsequent to the analysis result of the statistical analyzer 16, the recommended-drive detailed information calculating unit 20 of the server 10 shown in FIG. 4 extracts a recommended-drive detailed information from the analysis-result database 17. This recommended-drive detailed information is a detailed (relatively-large-volume) drive information including a plurality of recommended drive routes which is judged to be useful for the vehicle 1 in consideration of the travel history and the like of the vehicle 1. Then, at step S16, the recommended-drive detailed information is sent to the vehicle side 1 through the fixed-communication unit 12 shown in FIG. 4.

The recommended-drive detailed information sent from the server 10 is received by the fixed-communication unit 9 of the vehicle 1 as a processing of step S9 shown in FIG. 5. Then, at step S10, the recommended-drive detailed information is memorized and stored in the recommended-drive detailed information storage unit 18 of the navigation unit 3 shown in FIG. 4.

The processing which is executed in the vehicle side 1 also includes steps S1 to S8 of FIG. 5. The processing of steps S1 to S6 is the same as that of FIG. 2, as mentioned above.

That is, at step S1 of FIG. 5, it is judged whether the vehicle 1 is running or parked. If the vehicle 1 is in the running state, the program proceeds to step S2. At step S2, the current state of the vehicle 1 is checked. At step S3, the vehicle-travel-state detecting section 5 of FIG. 1 detects and collects (obtains) the amounts of driver's manipulations such as the accelerator manipulation amount, the brake manipulation amount and the steering-wheel manipulation amount; the running data of vehicle 1 such as the vehicle speed, the acceleration, the yaw rate and the location information obtained by GPS; and the failure information, as the large amount of detailed vehicle travel data. Moreover, at step S3, this vehicle travel data is memorized and accumulated in the vehicle-travel-data accumulating unit 7 in a time-series manner together with a detection-time information (including date information) which represents a time at which this vehicle travel data was detected. When this vehicle travel data has been memorized and accumulated in the vehicle-travel-data accumulating unit 7, this vehicle travel data loses its freshness and thereby becomes the past-accumulated vehicle travel data.

At step S4, the vehicle travel data accumulated in the vehicle-travel-data accumulating unit 7 as the past-accumulated vehicle travel data is reduced in volume in the predetermined format by the data thinning processing or the like of the data-communication condition setting unit 6. Thereby, this vehicle travel data is converted into the minimum necessary real-time travel data. Then, at step S5, the wireless communication unit 8 for mobile communications sends this real-time travel data to the data center 2 in real time during the running of the vehicle 1.

On the other hand, the data center side 2 receives the real-time travel data as the processing of step S17 of FIG. 6. Then, as the processing of step S18, the real-time analyzer 14 of FIG. 4 analyzes the current traveling/driving situation of the vehicle 1 on the basis of the real-time travel data.

The recommended-drive-information calculating unit 15 of FIG. 4 receives the traveling/driving situation of the currently-running vehicle 1 which is the analysis result of the real-time analyzer 14. At step S19, the recommended-drive-information calculating unit 15 checks the traveling/driving situation of the currently-running vehicle 1 against the huge amount of detailed drive information accumulated in the analysis-result database 17. Thereby, in real time, the recommended-drive-information calculating unit 15 analyzes which pattern included in the huge amount of detailed drive information is similar to the current traveling/driving situation of the vehicle 1. That is, a pattern similar to the current traveling/driving situation of the vehicle 1 is searched from many patterns of the huge amount of detailed drive information which exists in the analysis-result database 17. Thereby, for example, the recommended-drive-information calculating unit 15 identifies the number (code) of the recommended-drive detailed information which corresponds to the pattern obtained from the huge amount of detailed drive information, as the recommended drive information.

By so-doing, the number (code) of the recommended-drive detailed information is determined as the recommended drive information. Then, at step S20, the number of the recommended-drive detailed information is sent in real time to the currently-running vehicle 1 through the wireless communication unit 11, as the recommended drive information.

In the vehicle side 1, at step S6 subsequent to the access timing for sending the real-time travel data of step S5 of FIG. 5, the wireless communication unit 8 of FIG. 4 promptly receives the number of the recommended-drive detailed information identified by the recommended-drive-information calculating unit 15 of the data center 2 as the recommended drive information. When the number of the recommended-drive detailed information has been received, the recommended-drive information judging section 19 of FIG. 4 gets access to the recommended-drive detailed information storage unit 18 of the navigation unit 3 in which the (large amount of) recommended-drive detailed information exists, and thereby retrieves a recommended-drive detailed information corresponding to that number (code), as the processing of step S7 of FIG. 5. This recommended-drive detailed information includes, for example, the plurality of recommended drive route information as mentioned before.

The recommended-drive detailed information retrieved from the recommended-drive detailed information storage unit 18 is utilized as a route guide for the driver together with the route-guidance function of the navigation unit 3 itself or in place of the route-guidance function of the navigation unit 3.

According to the second embodiment, the route guide is conducted by using the recommended-drive detailed information which is more detailed than the recommended drive information of the first embodiment. Hence, in the second embodiment, more appreciate route guide can be achieved in addition to the same advantageous effects as the first embodiment.

Of course, the system shown in FIG. 4 according to the second embodiment is applicable also to an electric vehicle(s) in the same manner as the system according to the first embodiment.

Effects according to respective claims are as follows.

According to the invention recited in claim 5, the communication unit provided for mobile communications is configured to receive a recommended drive information for the vehicle, and the recommended drive information is calculated in the server on the basis of the vehicle travel data sent to the server by the communication unit provided for fixed-line communications and the partial data sent to the server by the communication unit provided for mobile communications. Therefore, the recommended drive information can be efficiently calculated.

According to the invention recited in claim 6, the vehicle travel data includes at least an information of driver's steering, and a state of the vehicle constituted by a vehicle speed, an acceleration/deceleration, a yaw rate and a vehicle location information. Therefore, the vehicle state can be precisely grasped.

According to the invention recited in claim 7, the data-communication condition setting unit configured to previously set a format of the partial data is provided in the vehicle side. Because the data format has been previously set, a communication efficiency is enhanced.

According to the invention recited in claim 8, the partial data set by the data-communication condition setting unit is sent in real time. Therefore, a communication responsivity is improved.

According to the invention recited in claim 9, the vehicle is an electric vehicle, and the communication unit provided for fixed-line communications is configured to send data through a charging cable during a charging of the electric vehicle. Therefore, the time necessary for the charging can be used efficiently.

According to the invention recited in claim 10, the communication unit provided for fixed-line communications is configured to send data through a wireless LAN. Therefore, a communication cable thereof is unnecessary and a degree of freedom of communicating spot can be secured.

According to the invention recited in claim 11, the recommended drive information is an information for recommended drive route. Therefore, the driver can be properly assisted.

According to the invention recited in claim 12, the communication unit provided for fixed-line communications is configured to send the vehicle travel data which was accumulated in the vehicle-travel-data accumulating unit and which exists after a data range sent during a previous stopped state of the vehicle. Therefore, an overlapped data can be prevented from being sent, so that the communication time (airtime) can be further shortened.

According to the invention recited in claim 13, the vehicle is an electric vehicle, and the communication unit provided for fixed-line communications is configured to send data during a charging of the electric vehicle. Therefore, the time necessary for the charging can be used efficiently.

According to the invention recited in claim 14, the communication unit provided for fixed-line communications is configured to send data through a charging cable. Therefore, the time necessary for the charging can be used efficiently.

According to the invention recited in claim 15, the communication unit provided for fixed-line communications is configured to send data through a wireless LAN. Therefore, a communication cable thereof is unnecessary and a degree of freedom of communicating site can be secured.

According to the invention recited in claim 16, the data-communication condition setting unit configured to previously set a format of the partial data is provided in the vehicle. Because the data format has been previously set, a communication efficiency is enhanced.

According to the invention recited in claim 17, the partial data set by the data-communication condition setting unit is sent in real time. Therefore, the communication responsivity is improved.

According to the invention recited in claim 18, the server includes a vehicle-travel-data database configured to accumulate the received vehicle travel data, a statistical analyzer configured to conduct a statistical analysis of data accumulated in the vehicle-travel-data database, and a real-time analyzer configured to analyze the partial data which has been selected on the predetermined condition and sent by the communication unit provided for mobile communications. The recommended drive information is calculated from analysis results of the statistical analyzer and the real-time analyzer. Therefore, the recommended drive information can be obtained more accurately.

According to the invention recited in claim 19, the server is configured to communicate with the vehicle via the communication unit provided for mobile communications when the vehicle is in a running state, and configured to communicate with the vehicle via the communication unit provided for fixed-line communications when the vehicle is in the stopped state. Therefore, an efficient communication system can be established.

According to the invention recited in claim 20, the server includes a vehicle-travel-data database configured to accumulate the vehicle travel data sent by the communication unit provided for fixed-line communications, a recommended-drive-information calculating unit configured to calculate a recommended drive route information as the recommended drive information by conducting a statistical analysis of data accumulated in the vehicle-travel-data database, and a real-time analyzer configured to analyze the partial data which has been selected on the predetermined condition and sent by the communication unit provided for mobile communications. The recommended drive route information is calculated from analysis results of the real-time analyzer and the statistical analyzer. Therefore, the recommended drive information can be obtained more accurately.

1. A communications device for a vehicle, comprising:
a vehicle-travel-data accumulating unit provided in the vehicle and configured to accumulate a travel data of the vehicle;
a communication unit provided in the vehicle for mobile communications, the communication unit being configured
to send a partial data of the vehicle travel data accumulated in the vehicle-travel-data accumulating unit to an external server, and
to receive a necessary information from the server; and
a communication unit provided for fixed-line communications and configured to send the vehicle travel data accumulated in the vehicle-travel-data accumulating unit to the server when the vehicle is in a stopped state.

2. The communications device according to claim 1, wherein
the communication unit provided for mobile communications is configured to receive a recommended drive information for the vehicle, and
the recommended drive information is calculated based on the vehicle travel data sent to the server by the communication unit provided for fixed-line communications and based on the partial data sent to the server by the communication unit provided for mobile communications.

3. A communications system for a vehicle, comprising:
a server provided in a data center;
a vehicle-travel-data accumulating unit provided in the vehicle and configured to accumulate a travel data of the vehicle;
a communication unit provided in the vehicle for mobile communications and configured to send a partial data of the vehicle travel data accumulated in the vehicle-travel-data accumulating unit to the server, the partial data being selected from the vehicle travel data on a predetermined condition; and
a communication unit provided for fixed-line communications and configured to send the vehicle travel data accumulated in the vehicle-travel-data accumulating unit to the server when the vehicle is in a stopped state,
wherein the server includes a recommended-drive-information calculating unit configured to calculate a recommended drive information for the vehicle on the basis of the vehicle travel data sent from the communication unit provided for fixed-line communications, and
the communication unit provided for mobile communications is configured to receive the recommended drive information calculated by the recommended-drive-information calculating unit.

4. A communications system for a vehicle, comprising:
a server provided in a data center;
a vehicle-travel-data accumulating unit provided in the vehicle and configured to accumulate a travel data of the vehicle;
a communication unit provided in the vehicle for mobile communications and configured to send a partial data of the vehicle travel data accumulated in the vehicle-travel-data accumulating unit to the server, the partial data being selected from the vehicle travel data on a predetermined condition; and
a communication unit provided for fixed-line communications and configured to send the vehicle travel data accumulated in the vehicle-travel-data accumulating unit to the server,
wherein the server includes a recommended-drive-information calculating unit configured to calculate a recommended drive information for the vehicle on the basis of the vehicle travel data sent from the vehicle, and
the communication unit provided for fixed-line communications is configured
to send the vehicle travel data accumulated in the vehicle-travel-data accumulating unit to the server when the vehicle is in a stopped state, and
to receive the recommended drive information calculated by the recommended-drive-information calculating unit and sent from the server.

5. The communications device according to claim 1, wherein
the communication unit provided for mobile communications is configured to receive a recommended drive information for the vehicle, and
the recommended drive information is calculated in the server on the basis of the vehicle travel data sent to the server by the communication unit provided for fixed-line communications and the partial data sent to the server by the communication unit provided for mobile communications.

6. The communications device according to claim 5, wherein
the vehicle travel data includes at least an information of driver's steering, and a state of the vehicle constituted by a vehicle speed, an acceleration/deceleration, a yaw rate and a vehicle location information.

7. The communications device according to claim 6, wherein
a data-communication condition setting unit configured to previously set a format of the partial data is provided in the vehicle.

8. The communications device according to claim 7, wherein
the partial data set by the data-communication condition setting unit is sent in real time.

9. The communications device according to claim 5, wherein
the vehicle is an electric vehicle, and
the communication unit provided for fixed-line communications is configured to send data through a charging cable during a charging of the electric vehicle.

10. The communications device according to claim 5, wherein
the communication unit provided for fixed-line communications is configured to send data through a wireless LAN.

11. The communications device according to claim 5, wherein
the recommended drive information is an information for recommended drive route.

12. The communications device according to claim 1, wherein
the communication unit provided for fixed-line communications is configured to send the vehicle travel data which was accumulated in the vehicle-travel-data accumulating unit and which exists after a data range sent during a previous stopped state of the vehicle.

13. The communications system according to claim 3, wherein
the vehicle is an electric vehicle, and
the communication unit provided for fixed-line communications is configured to send data during a charging of the electric vehicle.

14. The communications system according to claim 3, wherein
the communication unit provided for fixed-line communications is configured to send data through a charging cable.

15. The communications system according to claim 3, wherein
the communication unit provided for fixed-line communications is configured to send data through a wireless LAN.

16. The communications system according to claim 3, wherein
a data-communication condition setting unit configured to previously set a format of the partial data is provided in the vehicle.

17. The communications system according to claim 16, wherein
the partial data set by the data-communication condition setting unit is sent in real time.

18. The communications system according to claim 17,
wherein the server includes
a vehicle-travel-data database configured to accumulate the received vehicle travel data,
a statistical analyzer configured to conduct a statistical analysis of data accumulated in the vehicle-travel-data database, and
a real-time analyzer configured to analyze the partial data which has been selected on the predetermined condition and sent by the communication unit provided for mobile communications,
wherein the recommended drive information is calculated from analysis results of the statistical analyzer and the real-time analyzer.

19. The communications system according to claim 4, wherein the server is configured
to communicate with the vehicle via the communication unit provided for mobile communications when the vehicle is in a running state, and
to communicate with the vehicle via the communication unit provided for fixed-line communications when the vehicle is in the stopped state.

20. The communications system according to claim 19,
wherein the server includes
a vehicle-travel-data database configured to accumulate the vehicle travel data sent by the communication unit provided for fixed-line communications,
the recommended-drive-information calculating unit configured to calculate a recommended drive route information as the recommended drive information by conducting a statistical analysis of data accumulated in the vehicle-travel-data database, and
a real-time analyzer configured to analyze the partial data which has been selected on the predetermined condition and sent by the communication unit provided for mobile communications,
wherein the recommended drive route information is calculated from analysis results of the real-time analyzer and the statistical analysis.
